(19) United States
(12) Patent Application Publication
(10) Pub. No.: US 2004/0122682 A1
(43) Pub. Date: Jun. 24, 2004

(54) Method and system for efficient validation of nonprofit organizations

(76) Inventors: Allen B. Gruber, San Antonio, TX (US); Harry E. Gruber, Rancho Santa Fe, CA (US); Steve Klein, San Diego, CA (US)

Correspondence Address: MICHAEL A. RAHMAN, ESQ., KINTERA, INC., 9605 SCRANTON ROAD,, SAN DIEGO,, CA, 92121, US

(21) Appl. No.: 10/323,951

(22) Filed: Dec. 18, 2002

(51) Int. Cl. G06F 17/60

(52) U.S. Cl. 705/1

(57) ABSTRACT

A web-based automated method for validating a nonprofit organization is disclosed. In one embodiment, the method comprises the steps of applying online for a validation from a validator, receiving data pertaining to the nonprofit organization, analyzing the data to determine if the nonprofit organization is a bona fide organization, if the NPO is a bona fide organization, issuing the organization a validation, and if the NPO is not a bona fide organization, then denying the organization a validation. The method further comprises the step of providing an online seal of approval to the validated nonprofit organization. The method further comprises the step of displaying online the nonprofit organization data. The method further comprises the step of listing the validated nonprofit on an auction website. The method further comprises the step of receiving a donation from the sales proceeds of an auction.

### BACKGROUND

1. Field of Invention

The invention is directed to a web-based method and system for certifying and/or validating a nonprofit, charitable or fundraising organization and performing online transactions such as issuing a dot org domain name for an organization. The invention is further directed to establishing, based on the certification or validation, favorable transaction rates and determining eligibility for business opportunities suitable for the organizations.

2. Description of Related Art

Non-profit, charitable, philanthropic, social, political or other organizations (hereinafter generally referred to as nonprofit organizations) typically raise money through solicitations. The nonprofit organizations typically raise money by one or more fundraising methods such as mail campaigns, telephone calls and events. Recently the nonprofit organizations have begun to rely on the Internet for fundraising. The nonprofit organizations have recognized the power of the Internet and are now actively seeking to raise money and awareness online.

It is estimated that there are nearly one and a half million nonprofit organizations in the U.S. Each year, thousands of new nonprofit organizations are formed for various purposes. The nonprofit organizations are involved in charitable or philanthropic activities, including the advancement of the arts, sciences, medicine, and the environment.

Individuals, corporations and other businesses often sponsor the nonprofit organizations' activities or otherwise support the nonprofit organizations. Individuals, corporations and other businesses often make charitable donations to the nonprofit organizations. While corporate support benefits the nonprofit organizations, it also enhances corporate name recognition and goodwill. Individual and corporate support is an important source of revenue for the nonprofit organizations.

A question often faced by those who support the nonprofit organizations is whether a particular nonprofit organization of interest is bona fide or worthy of their support. Another question is whether a particular nonprofit organization is legitimate or not. There are many instances where unscrupulous entities have fraudulently operated as nonprofit organizations. These unscrupulous organizations solicit donations with the apparent purpose of supporting a worthy cause, but are in fact deceptive or self-serving. The money raised by these entities is not spent on the stated cause, but are rather misappropriated. Thus, when an individual or a corporation contemplates on making a donation or sponsoring a nonprofit organization's activity, it needs to know if that nonprofit organization is legitimate or bona fide. Since corporations and individuals do not have a convenient means of verifying the legitimacy or desirability of a nonprofit organization, they are sometimes hesitant or reluctant to support the nonprofit organization or the authenticity of their web site. If the corporations and individuals could have a convenient means of verifying the legitimacy of the nonprofit organization, they would be more willing to make donations and support the nonprofit organization. Also, if the nonprofit organizations could provide proof that they are bona fide and more, they would be more successful in their fundraising campaigns.

As noted before, the nonprofit organizations rely on the Internet to solicit and raise money. The nonprofit organizations typically use a domain name with a dot org (.org) as their address on the Internet. A nonprofit organization, for example, can operate a website with an address www.npo.org. In this exemplary address, npo is known as the domain name and the dot org (.org) is known as the top-level domain. The nonprofit organizations register with a registration authority or a registrar to receive a domain name with a dot org top-level domain.

There are different types of top-level domains. For example, governmental institutions use dot gov (.gov), military institutions use dot mil (.mil), and higher educational institutions use dot edu (.edu) as top-level domains.

The registration process for domain names vary depending on the type of top-level domain associated. For example, top-level domains such as dot mi, dot edu, and dot gov have complex registration processes requiring entities to verify that they are bona fide or legitimate governmental, military or educational institutions. Typically, an entity must provide proof that it is a bona fide higher educational, governmental or a military institution. The registration authority or registrar requires that the entity disclose certain information in order to allow the authority to check its status. This provides a degree of assurance that entities holding dot gov, dot edu and dot mil top-level domains are legitimate.

In contrast, domain names associated with some top-level domains do not have a complex registration process requiring verification, but are issued with minimal disclosure. For example, domain names with top-level domains such as dot com (.com), dot org (.org) and dot net (.net) can be obtained by merely completing a form and paying a required fee. The form can be completed online and the payment can also be made online, and an entity is then issued a domain name. This allows entities that are not legitimate or desirable to receive a dot org domain name.

An entity, for example, can receive dot org domain name with minimal disclosure. The entity simply completes a form and pays a required fee online. The entity need not verify to a registration or a certificate authority that it is a bona fide charitable organization. Thus, an entity that is not a legitimate nonprofit or a charitable organization can receive a dot org domain name and deceive unsuspecting members of the public. An entity that is not a bona fide nonprofit or a charitable organization can easily obtain a dot org domain name and solicit donations on the Internet.

Since an entity can easily obtain a dot org domain name without verifying that it is a bona fide charitable or nonprofit entity, it can set up a website as a charitable or a nonprofit entity and solicit donations online. Donors cannot be certain that the entity is a legitimate or a bona fide nonprofit organization. Often, donors are unsure of an entity's status and are hesitant to make a donation or pay a membership fee. Thus, if donors could be assured that an entity is a bona fide or a desirable charity or a nonprofit organization, they would be less reluctant to make a donation or pay a membership fee. Also if businesses can be assured that an entity is a bona fide or a legitimate charity or a nonprofit organization, they would be willing to enter into business relationships or conduct financial transactions with the nonprofit organization.

Accordingly, there is need for a method and system that provides an efficient verification of a nonprofit organization. There is a need for a method and system that provides a convenient means to determine whether a nonprofit organization is a bona fide or a legitimate entity. In addition, there also is a need for a system and method that provides a verification of a nonprofit organization in order to determine if the nonprofit qualifies for preferential treatment such as favorable transaction rates. There is also a need for a system and method that provides a verification of a nonprofit organization to determine if it qualifies for certain business opportunities.

### SUMMARY OF THE INVENTION

A web-based automated method for validating a nonprofit organization comprises the steps of applying online for a validation from a validator, receiving data pertaining to the nonprofit organization, analyzing the data to determine if the nonprofit organization is a bona fide organization, if the NPO is a bona fide organization, issuing the organization a validation. The method further comprises the step of providing an online seal of approval to the validated nonprofit organization. The method further comprises the step of displaying online the nonprofit organization data. The method further comprises the step of listing the validated nonprofit on an auction website. The method further comprises the step of receiving a donation from the sales proceeds of an auction.

### BRIEF DESCRIPTION OF THE DRAWINGS

For a more complete understanding of the present invention and the advantages thereof, reference is now made to the following brief description, taken in connection with the accompanying drawings and detailed description, wherein like reference numerals represent like elements, in which:

FIG. 1 is a flow diagram of the method steps in accordance with one embodiment of the invention;

FIG. 2 is a flow diagram in accordance with another embodiment of the invention; and

FIG. 3 is a flow diagram of the method steps for rating an NPO.

FIG. 4 is a flow diagram of the steps of making a donation during of an auction in accordance with one embodiment of the invention.

FIG. 5 illustrates a wide-area network linking an online auction website to a number of user stations.

### DETAILED DESCRIPTION OF THE INVENTION

The invention provides a solution for the above-mentioned problems associated with the verification of a nonprofit organization. In one embodiment, the invention provides an automated web-based system that allows validation of a nonprofit organization by a validation authority (hereinafter referred to as the “validator”) or any other entity. The validator can be an entity that provides a service to businesses or donors. The validator collects data pertaining to nonprofit organizations from various sources. For example, the validator obtains data regarding a nonprofit organization's reputation, track record, mission and purpose, financial records, and other data. This data allows the validator to analyze and determine whether a nonprofit organization is a bona fide and/or a reputed organization. The validator's report or analysis can be used by individuals, donors, businesses or other entities for various purposes. For example, individuals, donors, businesses or other entities can use the validator's report or analysis before making a donation, entering into a business relationship with the nonprofit organization, offering favorable financial terms and conditions to the nonprofit organization, conducting a financial transaction, or any other purpose.

In one embodiment, the invention provides an automated web-based system and method for conveniently verifying a nonprofit organization and classifying the nonprofit organization based on several criteria. In one embodiment, an NPO is rated or classified according to the following criteria: (a) compliance with federal laws; (b) compliance with state and local laws; (c) NPO's financial performance; (d) reputation and track-record of the NPO; and (e) the NPO's mission. Other criteria can be incorporated if desired. A corporation or an individual can conveniently access the web-based system to obtain a rating of the nonprofit organization. The rating can be used by the corporation prior to making a donation to the nonprofit organization, sponsoring the organization's activity, entering into a business relationship, offering favorable financial terms or conditions, or otherwise supporting the nonprofit organization. Likewise, the rating can be used by individuals prior to making a donation or otherwise supporting the nonprofit organization.

The invention provides a degree of assurance to the corporations, individuals and other potential donors that their donation or support is going to a bona fide or a legitimate nonprofit organization. Also, by removing the uncertainty about the legitimacy of the nonprofit organization, it is expected that the nonprofit organization will benefit from increased donations. Thus, by utilizing the invention, the nonprofit organizations will attain and/or maintain legitimacy and respectability and will be able to raise more donations.

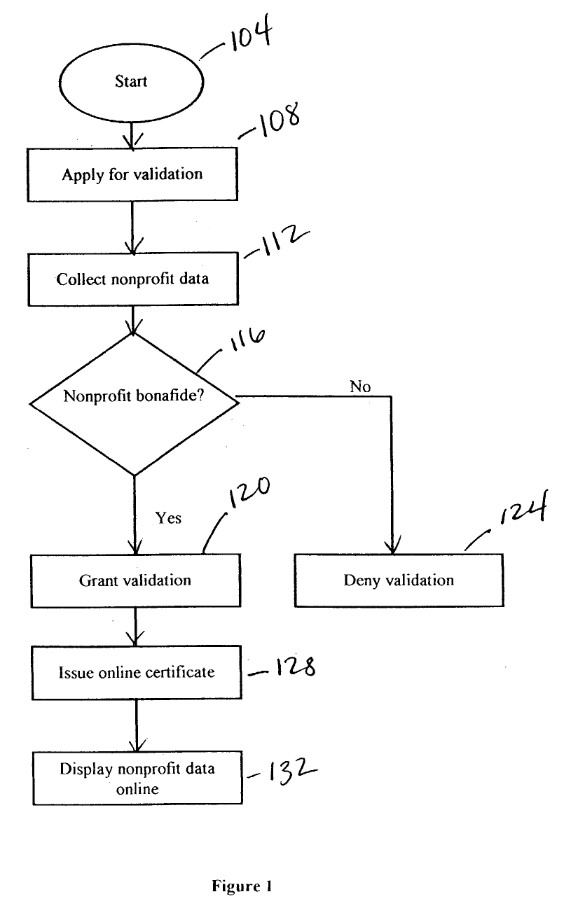

Referring now in more detail to the drawings, FIG. 1 is a high-level flow diagram of the method steps in accordance with one embodiment of the invention. The flow starts in step 104 and moves to step 108 where a nonprofit organization applies online for a validation or certification. In step 112, a validator collects data pertaining to the applicant nonprofit organization. In decision block 116 it is determined if the data indicates that the nonprofit organization is a bona fide or a legitimate entity. If the nonprofit organization is a bona fide or a legitimate entity, in step 120 the nonprofit organization is granted a certificate or a validation. If the data indicates that the nonprofit organization is not a bona fide or a legitimate entity, in step 124 the nonprofit organization is denied a certification or validation. In this example, a business entity or an individual seeking to make a donation or conduct a business transaction may seek a certification or validation of a nonprofit organization. In that case, the business entity or the individual can apply online to get a validation of the nonprofit organization.

In step 128 the nonprofit organization is issued an online certificate or a validation. The online certificate or validation provides assurance to corporate or individual donors that the nonprofit organization is a bona fide or a legitimate entity. In step 132, the nonprofit organization data is displayed online.

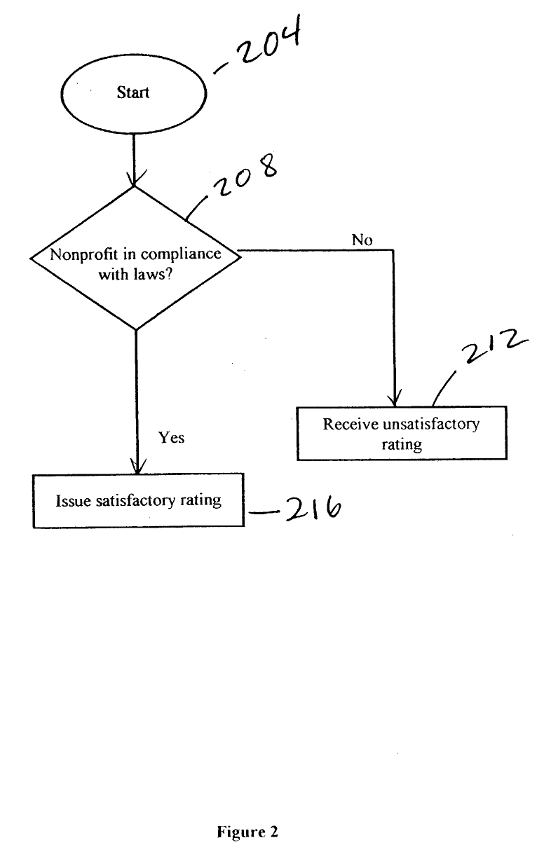

FIG. 2 is a flow diagram of the method steps in accordance with another embodiment of the invention. The flow starts in step 204 and moves to decision block 208 where it is determined if the nonprofit organization has complied with state and federal laws. For example, the validator checks if the nonprofit organization is registered as a nonprofit organization in one or more states. Since many states require a nonprofit to register prior to making any solicitations, registration as a nonprofit indicates compliance with state laws. In one embodiment, the validator checks if the nonprofit is registered in its principal place of business and in other states where it has conducted substantial fundraising activities. The validator also checks if the nonprofit has filed required documents in the appropriate state agencies, such as an annual financial report as required by most states. The validator also checks if the nonprofit has violated any state criminal laws. For example, the validator checks if the nonprofit has been indicted or convicted of fraud and other criminal activities.

The validator also checks if the nonprofit has complied with federal laws. For example, the validator checks if the nonprofit has been classified as a nonprofit organization by the Internal Revenue Service (IRS) and if the nonprofit has complied with IRS regulations for nonprofit organizations. For example, the validator checks if the nonprofit has a valid section 501 status under the IRS tax code. The validator also checks if the nonprofit has received any IRS ruling letter or has violated any IRS provisions or regulations. The validator also checks if the nonprofit has violated any federal criminal laws. For example, the validator checks if the nonprofit has been indicted or convicted of fraud and other criminal activities.

If the nonprofit is not in compliance with state or federal laws, the flow moves to step 212 where the nonprofit receives an unsatisfactory rating. This is in accordance with the position that a nonprofit needs to comply with state and federal laws to be a legitimate organization. This is also in accordance with the position that the nonprofit cannot deserve the trust and support of others if it is in violation of state and federal laws. Thus, if the nonprofit is determined to be in violation of state and federal laws, the nonprofit will receive an unsatisfactory rating in accordance with the invention.

If the nonprofit is in compliance with state and federal laws, the flow moves to step 216 where the nonprofit receives a satisfactory rating. Thus, only if the nonprofit is in compliance with state and federal laws, the nonprofit receives a satisfactory rating. A satisfactory rating implies that the nonprofit has satisfied the minimum standards required of a nonprofit.

In another embodiment, the nonprofit can receive a satisfactory rating even if it is found to be in compliance with only state or federal law, and not both state and federal laws. Thus, under this embodiment, more flexibility is provided in determining if a nonprofit meets minimum standards.

Corporations and individuals may proceed to make donations, pay a membership fee, enter into business relationships, offer favorable terms or otherwise conduct transactions with a nonprofit that has met the minimum standards. Others, however, may demand higher standards, and not mere compliance with minimum standards. Accordingly, the invention provides a means to evaluate a nonprofit and assign higher ratings if it qualifies.

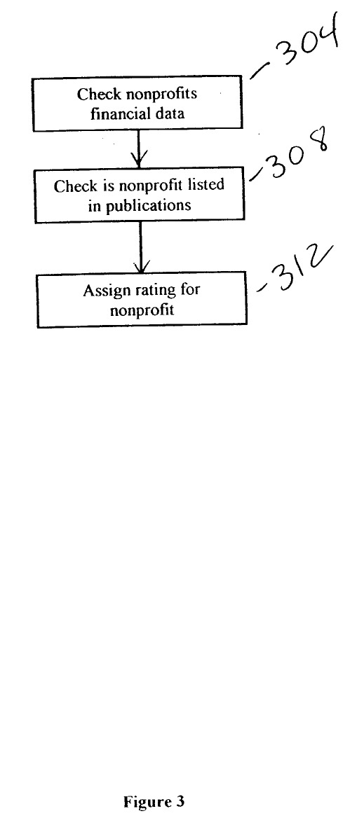

If a nonprofit is found to have met the minimum standards as described above, the nonprofit is further evaluated to determine if it qualifies for a higher rating. FIG. 3 is a flow diagram that illustrates the process of evaluating a nonprofit to determine if it qualifies for a higher rating. Referring now to FIG. 3, in step 304, the validator checks the nonprofit's financial data and/or performance. The financial information can be obtained from an organization such as Dunn & Bradstreet (D&B) or other sources. If the nonprofit spends a high percentage of the amount raised on administrative and other overhead expenses, which indicates that the nonprofit's activities may not be benefiting the charities as much as they should. If the nonprofit's spends only a modest percentage of the total amount of money raised on administrative and overhead costs, the nonprofit's activities are appropriately benefiting the charities.

The invention can utilize a scale to determine if the nonprofit is truly benefiting the charitable cause or if the entity is self-serving. For example, if the nonprofit spends more than 40% of its budget on fundraising and administrative cost and less than 60% on actual charitable cause, it may indicate the nonprofit is self-serving or inefficient.

Next, in step 308, it is determined if the nonprofit is listed in various reputed publications that serve the nonprofit industry. For example, Guidestar, Worth, Better Business Bureau and other magazines focus on nonprofit organizations and charities. These magazines also rate NPOs' according to their financial practices and other criteria. A listing or evaluation in one or more of these magazines is an indication of the nonprofit's overall reputation.

Next, in step 312, the nonprofit is assigned a rating. In one embodiment, the rating depends on the nonprofit's financial practices and its overall reputation. If the nonprofit is run efficiently and its overhead and administrative costs are reasonable, it is awarded a rating of “highly recommended.” Otherwise, the nonprofit is awarded a rating of “recommended.”

In one embodiment, the nonprofits or charities are issued an online seal of approval by the validator. For example, if a nonprofit meets minimum standards, the seal may indicate that. If the nonprofit is awarded a higher rating (e.g., highly recommended), the seal may indicate that. The nonprofits can post the seal on their websites. The validator may also post the seal of approval on its own website. Businesses can require the seal of approval from a validator as a prerequisite to entering a business relationship with the nonprofits or offering favorable terms and conditions.

In one embodiment, for security purposes the seal of approval is authenticated online by on or more methods well known in the art. Such authentication provides assurance to donors and users that the nonprofit indeed has a genuine seal of approval. Additional security can be provided by a lock (displayed online) that is well known in the art.

In one embodiment, the validator charges a fee for providing the validation services and providing the seal of approval. The nonprofit can pay the fee online of by other methods.

As noted before, various organizations and individuals can use the rating prior to making donations, entering a business relationship, offering favorable terms or otherwise conducting business with nonprofits. For example, consider a scenario where a nonprofit wants to be listed in an online auction website where goods and merchandizes are auctioned. In the online auction website, such as, for example, Ebay, a seller may decide to donate a portion of the proceeds to one or more nonprofits or charities listed on the website. A seller may also donate a merchandise to a charity so that the charity will receive the entire sales proceeds. Thus, it is lucrative for the nonprofits or charities to be listed on a popular auction website like Ebay.

The online auction website, however, may require that in order to be listed on its website, the charities must be bona fide and legitimate. The online auction website may require the charities to obtain a validation from a validator or that the charities maintain a higher rating. The online auction website may require that the charities maintain a rating of “highly recommended” to be listed on its website. The online auction website may require that the charities have a seal of approval from a validator and that the seal of approval is posted on the online auction website and/or the charity's website. A donor will be more inclined to make a donation to the charity if the seal of approval is posted online.

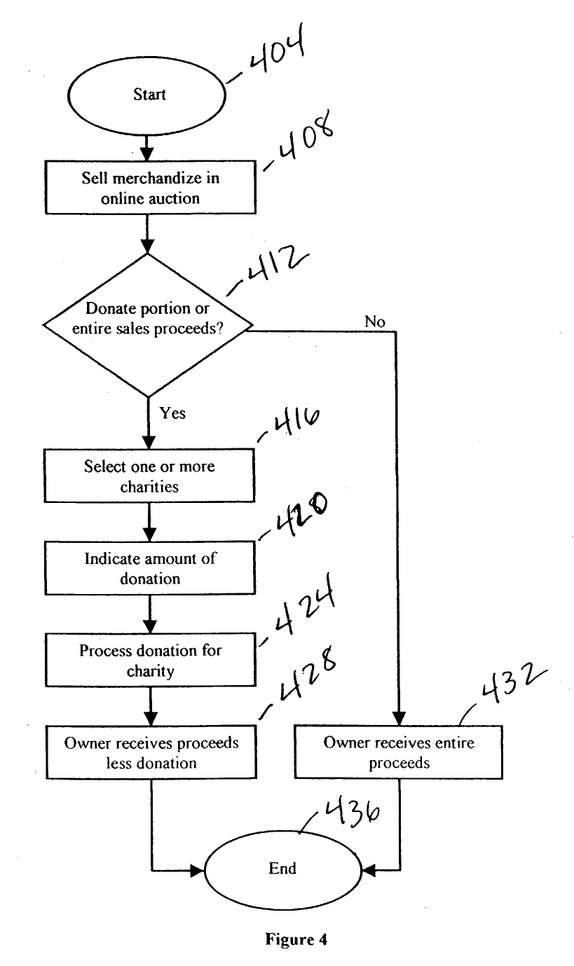

FIG. 4 is an example flow diagram of the steps of making a donation from the proceeds of an auction in accordance with one embodiment of the invention. The flow starts in step 404 and moves to step 408 where one or more merchandizes are sold in an online auction such as, for example, www.ebay.com. In decision block 412, the merchandize owner is asked if she would like to make a donation. The merchandise owner may decide to donate a portion of the proceeds or the entire proceeds to a charity listed on the website. If the owner wants to make a donation, the flow moves to step 416 where the owner selects one or more charities from the charities listed on the website. In step 420, the owner indicates the amount of donation she wishes to make. In step 424, the donation is processed for the designated charities. In step 428, the owner receives the proceeds less the donated amount. The flow ends in step 436. If in step 412, the owner declines to make a donation, the flow moves to step 432 where the owner receives the entire sales proceeds.

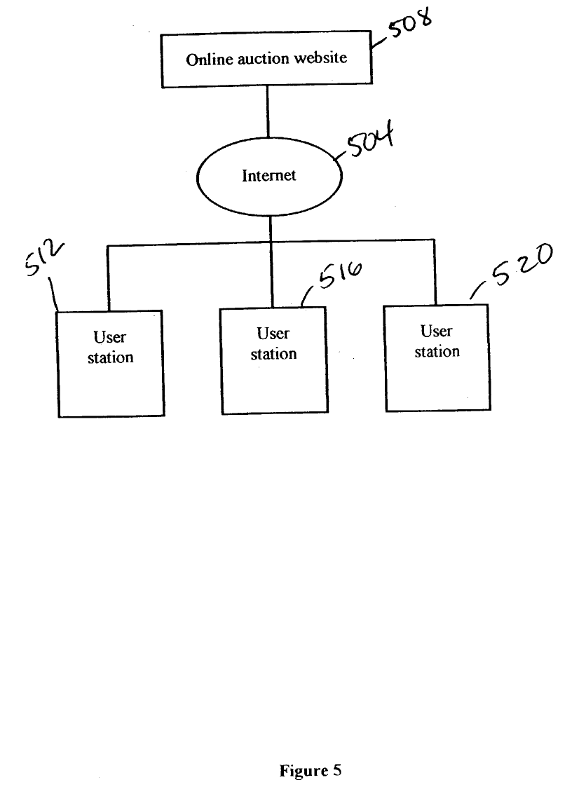

The present invention can be implemented in association with a wide-area network. In FIG. 5, a wide-area network (e.g., the Internet) 504 links an online auction website 504 to a number of user stations (e.g., personal computers) 512, 516, and 520. The sellers of merchandizes can use the user stations to sell on the auction website and conduct electronic transactions. The sellers can make a donation to one or more charities listed on the auction website from their personal computers. It is well known in the art how to structure such wide-area network connections to provide two-way communication between various user stations and the auction website connected to the network.

The invention can also be used in other applications. For example, credit agencies can use the invention to screen reputable nonprofits by providing favorably financing terms to only those that earn a “highly recommended” rating. States or other governmental organizations may require that nonprofits can conduct fundraising campaigns only if they earn a higher rating according to the invention.

In one embodiment, the program code for carrying out the steps in accordance with the present invention can be stored in a storage medium and made available for sale as a software program or a computer program product. For example, the program code can be stored in a compact disk (CD), a magnetic tape, or any other type of storage medium.

Although the preferred embodiments have been described, it should be understood that various changes, substitutions, and alterations can be made herein without departing from the scope of the present invention. It should be noted that the present invention can be implemented using virtually any computer system or other networking system and virtually any available programming language. Other examples of changes, substitutions, and alterations are readily ascertainable by one skilled in the art and could be made without departing from the spirit and scope of the present invention as defined by the following claims.

What is claimed is:

1. A web-based automated method for validating a nonprofit organization, the method comprising the steps of:
applying online for a validation from a validator;
receiving data pertaining to the nonprofit organization;
analyzing the data to determine if the nonprofit organization fulfills predetermined criteria;
if the nonprofit organization fulfills the predetermined criteria, issuing the organization a validation.

2. The method as recited in claim 1, further comprising the step of denying the nonprofit organization a validation if the nonprofit organization does not fulfill the predetermined criteria.

3. The method according to claim 1, further comprising the step of providing an online seal of validation to the validated nonprofit organization.

4. The method according to claim 1, further comprising the step of displaying online the nonprofit organization data.

5. The method according to claim 1, further comprising the step of listing the validated nonprofit on an auction website.

6. The method according to claim 5, further comprising the step of receiving a donation from the sales proceeds of an auction.

7. The method according to claim 1, wherein the validator charges a fee to the nonprofit organization for the validation.

8. The method according to claim 4, further comprising the step of authenticating the online seal of validation.

9. A web-based automated method for validating and rating a nonprofit organization, the method comprising the steps of:
accessing a website;
requesting validation of the nonprofit organization;
determining if the nonprofit organization has complied with state and federal laws;
if the nonprofit organization has complied with state and federal laws, then providing a satisfactory rating to the nonprofit organization.

10. The method as recited in claim 9, wherein the step of determining the nonprofit organization's compliance with laws further includes the step of verifying if the nonprofit has registered as a nonprofit organization in one or more states.

11. The method as recited in claim 10, wherein the step of determining the nonprofit's compliance with laws further includes the step of verifying if the nonprofit has filed an annual financial report as required by most states.

12. The method as recited in claim 9, wherein the step of determining the nonprofit's compliance with laws further includes the step of verifying if the nonprofit has violated any criminal laws.

13. The method as recited in claim 9, wherein the step of determining the nonprofit's compliance with laws further includes the step of verifying if the nonprofit is classified as a nonprofit organization by the Internal Revenue Service (IRS).

14. The method as recited in claim 9, wherein the step of determining the nonprofit's compliance with laws further includes the step of verifying if the nonprofit has complied with IRS regulations for nonprofit organizations.

15. The method as recited in claim 9, further comprising evaluating the nonprofit for a rating by checking the nonprofit's finances.

16. The method as recited in claim 15, further comprising evaluating the nonprofit for a rating by checking the nonprofit's reputation by determining if it is listed in reputed publications that serve the nonprofit industry.

17. The method as recited in claim 16, further comprising the step of assigning a rating based on the nonprofit's finances and its reputation.

18. The method according to claim 9, further comprising the step of listing the rated nonprofit on an auction website.

19. The method according to claim 18, further comprising the step of receiving a donation from the sales proceeds of an auction.

20. A web-based automated system for validating a nonprofit organization, comprising:
means for applying online for a validation from a validator;
means for receiving data pertaining to the nonprofit organization;
means for analyzing the data to determine if the nonprofit organization fulfills predetermined criteria;
means for issuing a validation if the nonprofit organization fulfills the predetermined criteria.

21. The system according to claim 20, further comprising means for providing an online seal of validation to the validated nonprofit organization.

22. The system according to claim 20, further comprising means for displaying online the nonprofit organization data.

23. The system according to claim 20, further comprising means for listing the validated nonprofit on an auction website.

24. The system according to claim 23, further means for receiving a donation from the sales proceeds of an auction.

25. The system according to claim 21, further comprising means for authenticating the online seal of validation.

26. A computer-readable medium having computer executable instructions for a web-based automated method for validating a nonprofit organization, the method comprising the steps of:
applying online for a validation from a validator;
receiving data pertaining to the nonprofit organization;
analyzing the data to determine if the nonprofit organization fulfills predetermined criteria;
if the nonprofit organization fulfills the predetermined criteria, issuing the organization a validation.
